(19) United States
(12) Patent Application Publication
(10) Pub. No.: US 2024/0002586 A1
(43) Pub. Date: Jan. 4, 2024

(54) CURABLE COMPOSITIONS, COMPOSITE FOAM, METHOD OF MAKING THE SAME, AND ARTICLE INCLUDING THE SAME

(71) Applicant: 3M INNOVATIVE PROPERTIES COMPANY, St. Paul, MN (US)

(72) Inventors: Binhong Lin, Woodbury, MN (US); Mario A. Perez, Burnsville, MN (US); Phillip D. Hustad, St. Paul, MN (US); Erik M. Townsend, South St. Paul, MN (US)

(21) Appl. No.: 18/039,775

(22) PCT Filed: Nov. 29, 2021
(86) PCT No.: PCT/IB2021/061077

§ 371 Date: Jun. 1, 2023

Related U.S. Application Data
(60) Provisional application No. 63/120,567, filed on Dec. 2, 2020.

(51) Int. Cl. C08G 61/08; C08K 7/28; C08J 9/32; C08J 9/00

(52) U.S. Cl. CPC C08G 61/08; C08K 7/28; C08J 9/32; C08J 9/0066; C08G 2261/3324; C08G 2261/135; C08G 2261/1526; C08G 2261/418; C08J 2365/00; C08J 2203/22; C08G 2261/592

(57) ABSTRACT

A curable composition comprises an addition polymerizable cycloolefin comprising a ring containing a single car-bon-carbon double bond; an addition polymerization catalyst; and at least one of hollow glass microspheres, expanded polymeric mi-crospheres, or expandable polymeric microspheres. The curable composition may be 1-part or 2-part. Methods of curing the curable composition are disclosed. Cured compositions, and articles including the same are also disclosed.

### TECHNICAL FIELD

The present disclosure broadly relates to compositions curable by addition polymerization, composite foams, articles produced therefrom, and methods of making the same.

### BACKGROUND

Fifth-generation wireless (5G) is the latest iteration of cellular technology, engineered to greatly increase the speed and responsiveness of wireless networks. 5G Communication technology promises significant advancements, such as faster speed, lower latency, improved connection density and wider coverage; thus enabling implementation of Internet of Things (IoT), augmented reality (AR) or virtual reality (VR) applications, factory automation, vehicular communications and other applications where security, reliability, quality of service and efficiency are critical.

With 5G, data transmitted over wireless broadband connections can travel at multigigabit speeds, with potential peak speeds as high as 20 gigabits per second (Gbps) by some estimates. The increased speed is achieved partly by using higher frequency radio waves than current cellular networks. However, higher frequency radio waves have a shorter range than the frequencies used by previous networks. To ensure wide service, 5G networks operate on up to three frequency bands, low, medium, and high. A 5G network will be composed of networks of up to 3 different types of cell, each requiring different antennas, each type giving a different tradeoff of download speed vs. distance and service area. 5G cellphones and wireless devices will connect to the network through the highest speed antenna within range at their location.

Low-band 5G uses a similar frequency range as current 4G cellphones, 600-700 MHz giving download speeds a little higher than 4G: 30-250 megabits per second (Mbit/s). Low-band cell towers will have a similar range and coverage area to current 4G towers. Mid-band 5G uses microwaves of 2.5-3.7 GHz, currently allowing speeds of 100-900 Mbit/s, with each cell tower providing service up to several miles radius. High-band 5G typically uses frequencies of 25-39 GHz, near the bottom of the millimeter wave band, to achieve download speeds of 1-3 gigabits per second (Gbit/s), comparable to cable internet.

Many materials used in the telecommunication industry today do not perform well at 5G frequencies. Thus, the higher frequencies of 5G necessitate the identification and development of materials that can function at those frequencies and not interfere with proper functioning of electronic devices communicating at high-band wavelengths. Examples include cell phones, extra base stations in addition to existing towers, and automotive radar/self-driving cars).

There is a need for low dielectric/low loss tangent (tan δ) materials that can perform at high band GHz (mm wavelength) frequencies. Other desirable material properties include low moisture uptake (since water dramatically increases dielectric constant) and thermal management capability (since higher power generates more heat), and for mm wave antennae substrates, adhesion to copper and stability at 250° C. (for solder re-flow).

### SUMMARY

The present disclosure provides low dielectric constant, low dielectric loss, water-resistant materials suitable for use in 5G applications among other things.

In a first aspect, the present disclosure provides a curable composition comprising:
at least one monomer comprising an addition polymerizable cycloolefin comprising a ring containing a single carbon-carbon double bond;
an addition polymerization catalyst; and
at least one of hollow glass microspheres, expanded polymeric microspheres, or expandable polymeric microspheres.

In a second aspect, the present disclosure provides a two-part curable composition comprising:
a Part A comprising
   a first liquid vehicle;
   a procatalyst; and
a Part B comprising
   a second liquid vehicle, and
   an activator that when combined with the procatalyst generates an addition polymerization catalyst,
wherein at least one of the first or second liquid vehicle comprises an addition polymerizable cycloolefin comprising a ring containing a single carbon-carbon double bond, and
wherein at least one of the Part A or Part B further comprises at least one of hollow glass microspheres, expanded polymeric microspheres, or expandable polymeric microspheres.

The curable compositions can be used to manufacture a composite foam. Accordingly, in another aspect, the present disclosure provides a composite foam comprising:
a polymer matrix made by addition polymerization of monomers comprising cycloolefin comprising a ring containing a single carbon-carbon double bond;
an addition polymerization catalyst; and
at least one of hollow glass microspheres or expanded polymeric microspheres.

In yet another aspect, the present disclosure provides an article comprising a first substrate in contact with a composite foam according to the present disclosure.

In yet another aspect, the present disclosure provides a method comprising:
providing a curable composition comprising at least one monomer comprising a cycloolefin comprising a ring containing a single carbon-carbon double bond;
   an addition polymerization catalyst; and
   at least one of hollow glass microspheres, expanded polymeric microspheres, or expandable polymeric microspheres; and
heating the curable composition to provide a composite foam according to the present disclosure.

As used herein:

The terms “olefin” and “olefinic” refer to compounds composed of carbon and hydrogen and having at least one non-aromatic carbon-carbon double bond.

The term “stereoisomers” refers to isomers having the same molecular formula and sequence of bonded atoms (constitution) but differ in the three-dimensional orientations of their atoms in space.

The term “enantiomers” refers to stereoisomers that are related as mirror images of one another.

The term “diastereomers” refers to stereoisomers that are not related as enantiomers. As used herein, cis-trans (or E-Z) isomers fall within the scope of the term diastereomers.

Features and advantages of the present disclosure will be further understood upon consideration of the detailed description as well as the appended claims.

### BRIEF DESCRIPTION OF THE DRAWINGS

FIG. 1 is a schematic side view of an exemplary article 100 according to the present disclosure.

It should be understood that numerous other modifications and embodiments can be devised by those skilled in the art, which fall within the scope and spirit of the principles of the disclosure. The FIGURES may not be drawn to scale.

### DETAILED DESCRIPTION

As used herein, the term “addition polymerization” (also sometimes referred to in the art as vinyl-addition polymerization) refers to a polymerization process involving an olefin coordination-insertion pathway mediated by an organometallic catalyst. A schematic depiction is shown in Scheme I, below.

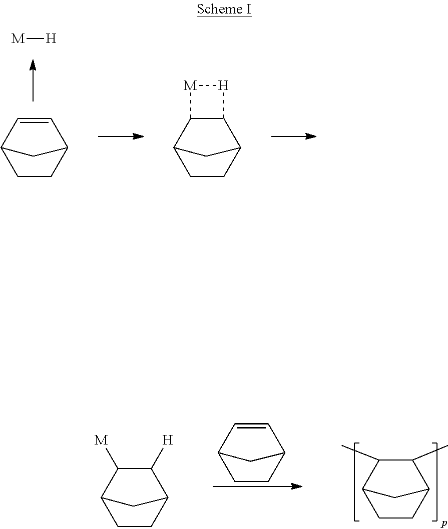

where M-H indicates an addition polymerization catalytic species having a metal hydride bond, and p represents an integer greater than 10. This process is distinguished from a common alternative polymerization method, Ring-opening Metathesis Polymerization (ROMP), both in mechanism and end product. ROMP polymers contain double bonds in the polymer backbone, whereas addition polymers according to the present disclosure do not.

Curable compositions according to the present disclosure include at least one addition polymerizable monomer comprising a cycloolefin comprising a ring containing a single carbon-carbon double bond, optionally not in conjugation with an aromatic ring. While a single cycloolefin (often as a mixture of stereoisomers) may be used in many embodiments, it is also contemplated that combinations of two or more cycloolefins that are not related as stereoisomers, each comprising a ring containing a single carbon-carbon double bond, may also be used.

Examples of suitable addition polymerizable cycloolefins comprising a ring containing a single carbon-carbon double bond include norbornene, 1-methylnorbornene, 5-methylnorbornene, 7-methylnorbornene, 5-(2-ethylhexyl)norbornene, 1-pentadecylnorbornene, 5,5-dimethylnorbornene, 5,5-dibutylnorbomene, 5,7-dibutylnorbornene, 5-methyl-5-ethylnorbornene, 5,6-didodecylnorbomene, 5-ethyl-6-propylnorbomene, 5,5,6,6-tetramethylnorbomene, 1-phenylnorbornene, 5-naphthylnorbomene, 5,5-diphenylnorbomene, 5-vinylnorbomene, 7-vinylnorbornene, 5-propenyl-6-methylnorbornene, 5-tolylnorbornene, 5-benzylnorbomene, 5-cyclopentylnorbomene, 1,5,5-trimethylnorbornene, 5-isopropenylnorbomene, 1-isopropylnorbomene, 1-ethylnorbomene, 1,5-dimethylnorbornene, 1,5-diethylnorbomene, 1,6-dimethylnorbornene, 5,5,6-trimethylnorbornene, 5-cyclopropylnorbomene, 5-cyclohexylnorbomene, 5-cyclopentenylnorbomene, 5-(2′-norbomyl)norbomene, 5-phenylnorbornene, 5-benzylnorbom-2-ene, 5-(2′-phenylethyl)norbomene, 5-(3′-phenylpropyl)norbomene, 5-(4′-phenylbutyl)norbomene, 2,5-norbornadiene, cyclohexene, cyclopentene, dicyclopentadiene, 2,5-norbornadiene, bicyclo[2.2.2]-2-octene, indene, 5-methylenenorbornene, 5-ethylidenenorbomene, 5-propylidenenorbornene, 5-hexylidenenorbomene, 5-decylidenenorbomene, 5-methylene-6-methylnorbornene, 5-methylene-6-hexylnorbomene, 5-cyclohexylidenenorbomene, 5-cyclooctylidenenorbornene, 7-isopropylidenenorbornene, 5-methyl-7-isopropylidenenorbornene, 5-hydroxymethyl-6-methylenenorbornene, 7-ethylidenenorbomene, 5-methyl-7-propylidenenorbomene, t-butyl

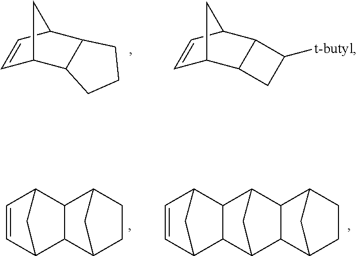

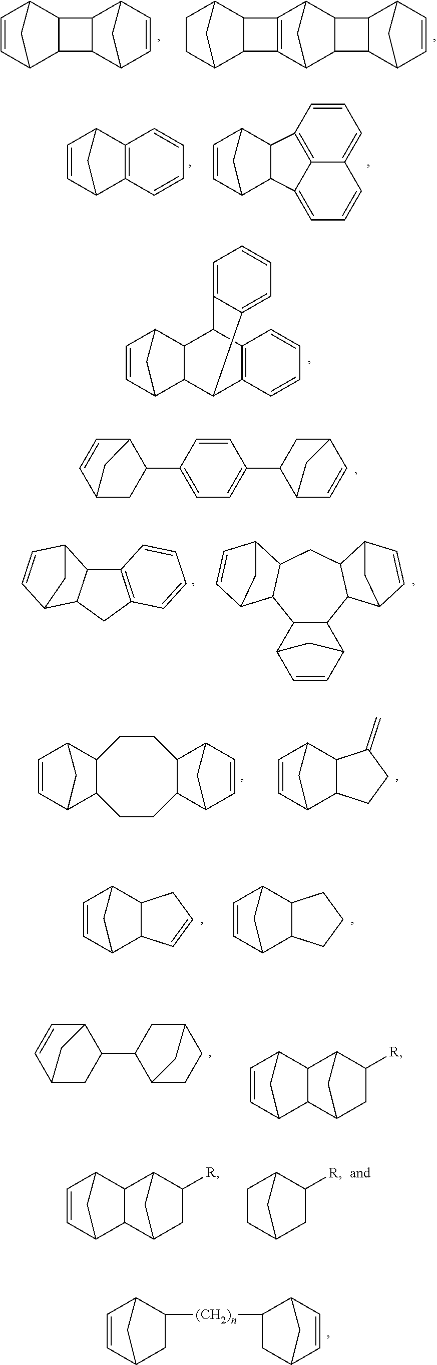

wherein R represents an alkyl group having from 1 to ten carbon atoms (e.g., methyl, ethyl, propyl, butyl, pentyl, hexyl, heptyl, octyl, nonyl, decyl), and n represents an integer from 1 to 10 (e.g., 1, 2, 3, 4, 5, 6, 8, 10). In some preferred embodiments, the addition polymerizable cycloolefin comprises a ring having a single carbon-carbon bond contains a skeletal carbon atom residue of norbornene. In some preferred embodiments, the addition polymerizable cycloolefin comprises a ring having a single carbon-carbon bond is represented by the formula

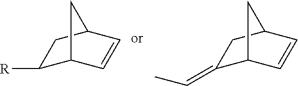

or a stereoisomer thereof, wherein R represents H or an alkyl group having up to ten carbon atoms. Further addition polymerizable cycloolefins can be readily prepared according to conventional techniques such as, for example, Diels-Alder cycloaddition of a 1,3-conjugated diene (e.g., cyclopentadiene) to an olefinic dienophile.

In some embodiments, the curable composition may upon curing result in an uncrosslinked polymer matrix, while in others the polymer matrix may be chemically crosslinked. This can be caused by including addition polymerizable olefins having two or more addition polymerizable non-conjugated carbon-carbon double bonds. Examples may include 5-cyclopentenylnorbornene, 2,5-norbornadiene, dicyclopentadiene, bicyclo[2.2.2]-2-octene,

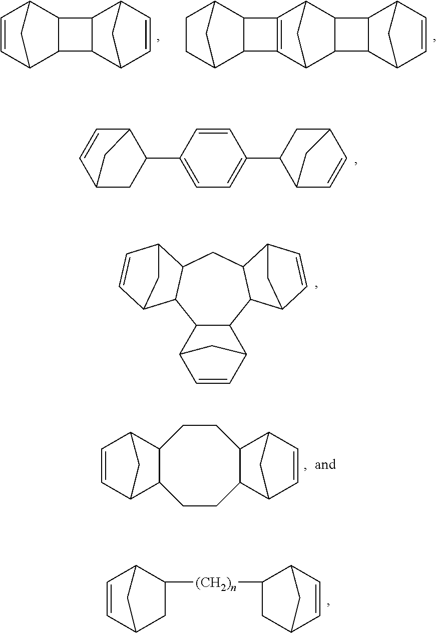

wherein R represents an alkyl group having from 1 to ten carbon atoms (e.g., methyl, ethyl, propyl, butyl, pentyl, hexyl, heptyl, octyl, nonyl, decyl), and n represents an integer from 1 to 10 (e.g., 1, 2, 3, 4, 5, 6, 8, 10).

In some embodiments, the amount of cycloolefin comprising a ring containing a single carbon-carbon double bond comprises at least 50, at least 60, at least 70, at least 80, or even at least 90 weight percent of addition polymerization monomers present in the curable composition; however, this is not a requirement.

Compositions according to the present disclosure contain one or more addition polymerization catalysts. A great many addition polymerization catalysts are known in the art and are typically based on organometallic catalysts comprising Ti, Zr, Cr, Co, Fe, Cu, Ni, or Pd. Of these, addition polymerization catalysts comprising Ni or Pd are most commonly-used. There is voluminous literature on organometallic addition polymerization catalysts, and especially for norbornene-type monomers. Generally, the active catalyst species is a cationic transition metal complex that has an alkyl or allyl ligand and a weakly coordinating anion. The addition polymerization catalyst may be included in curable compositions according to the present disclosure a single active species (or a combination thereof) or it may be provided as a precursor combination of a procatalyst and an activator; for example, as is common in the art. Generally, the procatalyst provides the active site for the olefin insertion mechanism that forms the addition polymer. Combination with the activator converts the procatalyst into its active form.

In some embodiments, appropriate catalyst(s) and procatalyst/activator combinations for the addition polymerization of cycloolefins comprising a ring having a single carbon-carbon bond may include Group 10 (i.e., of the Periodic Table of the Elements) catalyst(s) or procatalyst/activator combinations; for example, Ni-based, Pd-based, or Pt-based addition polymerization catalysts. In some preferred embodiments, late metal (e.g., Ni- or Pd-based) procatalysts have allyl/alkyl ligands as well as chloride ligands. These procatalysts are activated by the addition of monovalent metal (Li, Na, Ag) salts of weakly coordinating anions (e.g., BF₄, tetrakis(3,5-bis(trifluoromethyl)phenyl)borate (BARF), or perfluorotetraphenylborate).

Exemplary suitable procatalysts include: (1,1-dimethylallyl)palladium(triisopropylphosphine) trifluoroacetate, (2-chloroallyl)palladium(triisopropylphosphine) trifluoroacetate, (allyl)palladium-(tricyclohexylphosphine) chloride, (allyl)palladium(tricyclohexylphosphine) p-tolylsulfonate, (allyl)palladium(tricyclohexylphosphine) triflate, (allyl)palladium(tricyclohexylphosphine) triflimide, (allyl)palladium(tricyclohexylphosphine) trifluoroacetate, (allyl)palladium(triisopropylphosphine) triflate, (allyl)palladium(triisopropylphosphine) triflimide, (allyl)palladium(triisopropylphosphine) trifluoroacetate, (allyl)palladium(trinaphthylphosphine) triflate, (allyl)palladium(tri-o-tolylphosphine) acetate, (allyl)palladium(tri-o-tolylphosphine) nitrate, (allyl)palladium(tri-o-tolylphosphine) triflate, (allyl)palladium(triphenylphosphine) triflate, (allyl)palladium(triphenylphosphine) triflimide, (allyl)palladium(tricyclopentylphosphine) triflate, (allyl)palladium(tri-o-tolylphosphine) chloride, (allyl)Pd(AsPh₃)Cl,(allyl)Pd(PPh₃)Cl, (allyl)Pd(PCy₃)C₆F₅, (allyl)Pd(P-i-Pr₃)C₆F₅, (allyl)Pd(PMe₃)OC(O)CH₂CH═CH₂, (allyl)Pd(SbPh₃)Cl, (C₂H₅)Pd(PMe₃)2Br, (C₂H₅)Pd(PMe₃)2Br, (C₂H₅)Pd(PMe₃)₂Cl(Ph), (CH₃)Pd(P(i-Pr)₃)₂O₃SCF₃, (CH₃)Pd(PMe₂Ph)₂Cl, (CH₃)Pd(PMe₃)₂Cl, (CH₃)Pd(PMe₃)NO₃, (crotyl)palladium(tricyclohexylphosphine) triflate, (crotyl)palladium(tricyclopentylphosphine) triflate, (crotyl)palladium(triisopropylphosphine) triflate, (cyclooctadiene)palladium(II) dichloride, (hydrido)palladiumbis(tricyclohexylphosphine) chloride, (hydrido)palladiumbis(tricyclohexylphosphine) formate (hydrido)palladiumbis(tricyclohexylphosphine) nitrate, (hydrido)palladiumbis(tricyclohexylphosphine) triflate, (hydrido)palladiumbis(tricyclohexylphosphine) trifluoroacetate, (hydrido)palladiumbis(triisopropylphosphine) chloride, (hydrido)palladiumbis(triisopropylphosphine) triflate, (Me₂NCH₂C₆H₄)Pd(O₃SCF₃)P(cyclohexyl)₃, (methallyl)palladium(tricyclohexylphosphine) acetate, (methallyl)palladium(tricyclohexylphosphine) chloride, (methallyl)palladium(tricyclohexylphosphine) triflate, (methallyl)palladium(tricyclohexylphosphine) triflimide, (methallyl)palladium(tricyclohexylphosphine) trifluoroacetate, (methallyl)-palladium(tricyclopentylphosphine) acetate, (methallyl)palladium(tricyclopentylphosphine) chloride, (methallyl)palladium(tricyclopentylphosphine) triflate, (methallyl)palladium(tricyclopentylphosphine) triflimide, (methallyl)palladium(tricyclopentylphosphine) trifluoroacetate, (methallyl)palladium-(triisopropylphosphine) acetate, (methallyl)palladium(triisopropylphosphine) chloride, (methallyl)-palladium(triisopropylphosphine) triflate, (methallyl)palladium(triisopropylphosphine) triflimide, (methallyl)palladium(triisopropylphosphine) trifluoroacetate, (methallyl)Pd(AsPh₃)Cl, (methallyl)-Pd(P[(OCH₂)₃]CH)Cl, (methallyl)Pd(PBu₃)Cl, (methallyl)Pd(PPh₃)Cl, (methallyl)Pd(SbPh₃)Cl, (Ph)Pd(PMe₃)₂Br, (PMe₃)₂Br, (η¹-benzyl)Pd(PEt₃)₂Cl, [(allyl)Pd(HOCH₃)(P-i-Pr₃)][B(O₂-3,4,5,6-Br₄C₆)₂], [(allyl)Pd(HOCH₃)(P-i-Pr₃)][B(O₂-3,4,5,6-Cl₄C₆)₂], [(allyl)Pd(HOCH₃)(P-i-Pr₃)]-[B(O₂C₆H₄)z], [(allyl)Pd(OEt₂)(PCy₃)][BF₄], [(allyl)Pd(OEt₂)(PCy₃)][PF₆], [(allyl)Pd(OEt₂)(P-iPr₃)], [(allyl)Pd(OEt₂)(P-i-Pr₃)][BPh₄], [(allyl)Pd(OEt₂)(P-i-Pr₃)][ClO₄],[(allyl)Pd(OEt₂)(PPh₃)][SbF₆], [(allyl)Pd(OEt₂)(P-i-Pr₃)][PF₆], [(allyl)Pd(OEt₂)(PPh₃)][BF₄], [(allyl)Pd(OEt₂)(PPh₃)][PF₆], [(dimethylamino)methyl]phenyl-C,N-}-palladium(tricyclohexylphosphine) triflate, [SbF₆][(allyl)-Pd(OEt₂)(P-i-Pr₃)][BF₄], {2-[(dimethylamino)methyl]phenyl-C,N-}-palladium(tricyclohexylphosphine) chloride, dibromobis(benzonitrile)palladium(II), dichlorobis(acetonato)palladium (II), dichlorobis-(acetonitrile)palladium(II), dichlorobis(benzonitrile)palladium (II), palladium (II) bis(tricyclohexylphosphine) bis(trifluoroacetate), palladium (II) bis(tricyclohexylphosphine) diacetate, palladium (II) bis(tricyclohexylphosphine) dibromide, palladium (II) bis(tricyclohexylphosphine) dichloride, palladium (II) bis(triisopropylphosphine) bis(trifluoroacetate), palladium (II) bis(triisopropylphosphine) diacetate, palladium (II) bis(triisopropylphosphine) dibromide, palladium (II) bis(triisopropylphosphine) dichloride, palladium (II) bis(triphenylphosphine) bis(trifluoroacetate), palladium (II) bis(triphenylphosphine) diacetate, palladium (II) bis(triphenylphosphine) dibromide, palladium (II) bis(triphenylphosphine) dichloride, palladium (II) bis(tri-p-tolylphosphine) bis(trifluoroacetate), palladium (II) bis(tri-p-tolylphosphine) diacetate, palladium (II) bis(tri-p-tolylphosphine) dibromide, palladium (II) bis(tri-p-tolylphosphine) dichloride, palladium (II) ethyl hexanoate, palladium(II) acetylacetonate, palladium(II) bis(trifluoroacetate), palladium(II) ethylhexanoate, Pd(acetate)₂(PPh₃)₂, Pd(PMe₃)₂Cl,(CH₃)Pd, PdBr₂(P(p-tolyl)₃)₂, PdBr₂(PPh₃)₂, PdCl₂(P(cyclohexyl)₃)₂, PdCl₂(P(o-tolyl)₃)₂, PdCl₂(PPh₃)₂; platinum (II) chloride; platinum (II) bromide, platinum bis(triphenylphosphine)dichloride, trans-PdCl₂(PPh₃)₂, (methallyl)nickel-(tricyclohexylphosphine) triflate, nickel acetylacetonate, nickel carboxylates, nickel (II) chloride, nickel(II) bromide, nickel ethylhexanoate, nickel (II) trifluoroacetate, nickel (II) hexafluoroacetylacetonate, NiCl₂(PPh₃)₂, NiBr₂P(p-tolyl)₃)₂, (allyl)platinum(tricyclohexylphosphine) chloride, (allyl)platinum(tricyclohexylphosphine) triflate, allylchloro[1,3-bis(2,6-di-i-propylphenyl)-4,5-dihydroimidazol-2-ylidene]palladium(II), allylchloro[1,3-bis(2,6-di-i-propylphenyl)imidazol-2-ylidene]palladium(II), chloro[(1,2,3-r)-3-phenyl-2-propenyl][1,3-bis(2,6-di-i-propylphenyl)-4,5-dihydroimidazol-2-ylidene]palladium (II), chloro[(1,2,3-η)-3-phenyl-2-propenyl][1,3-bis(2,6-di-i-propylphenyl)imidazol-2-ylidene]palladium (II), allylchloro[1,3-bis(2,6-di-i-propylphenyl)-4,5-dihydroimidazol-2-ylidene]nickel (II), allylchloro[1,3-bis(2,6-di-i-propylphenyl)imidazol-2-ylidene]nickel(II), chloro[(1,2,3-i)-3-phenyl-2-propenyl][1,3-bis(2,6-di-i-propylphenyl)-4,5-dihydroimidazol-2-ylidene]nickel (II), and chloro[(1,2,3-η)-3-phenyl-2-propenyl][1,3-bis(2,6-di-i-propylphenyl)imidazol-2-ylidene]nickel (II).

Addition of a Lewis base, which coordinately bonds to the metal atom, may improve the activity of addition polymerization catalysts and/or procatalysts. That is, the Lewis base is bonded to the metal atom by sharing both of its lone pair of electrons. Any Lewis base known in the art can be used for this purpose. Preferably, the Lewis base can dissociate readily under the polymerization conditions.

Exemplary suitable Lewis bases include substituted and unsubstituted nitriles, including alkyl nitrile, aryl nitrile or aralkyl nitrile; phosphine oxides, including substituted and unsubstituted trialkylphosphine oxides, triarylphosphine oxides, triaralkylphosphine oxides, and various combinations of alkyl, aryl and aralkylphosphine oxides; substituted and unsubstituted pyrazines; substituted and unsubstituted pyridines; phosphites, including substituted and unsubstituted trialkyl phosphites, triaryl phosphites, triaralkyl phosphites, and various combinations of alkyl, aryl and aralkyl phosphites; phosphines, including substituted and unsubstituted trialkylphosphines, triarylphosphines, triaralkylphosphines, and various combinations of alkyl, aryl, and aralkyl phosphines. Various other Lewis bases that may be used include various ethers, alcohols, ketones, amines and anilines, arsines, and stibines. In some embodiments, the Lewis base can be selected from acetonitrile, propionitrile, n-butyronitrile, tert-butyronitrile, benzonitrile (C₆H₅CN), 2,4,6-trimethylbenzonitrile, phenyl acetonitrile (C₆H₅CH₂CN), pyridine, 2-methylpyridine, 3-methylpyridine, 4-methylpyridine, 2,3-dimethylpyridine, 2,4-dimethylpyridine, 2,5-dimethylpyridine, 2,6-dimethylpyridine, 3,4-dimethylpyridine, 3,5-dimethylpyridine, 2,6-di-t-butylpyridine, 2,4-di-t-butylpyridine, 2-methoxypyridine, 3-methoxypyridine, 4-methoxypyridine, pyrazine, 2,3,5,6-tetramethylpyrazine, diethyl ether, di-n-butyl ether, dibenzyl ether, tetrahydrofuran, tetrahydropyran, benzophenone, triphenylphosphine oxide, triphenyl phosphate and PR₃¹, wherein each R is independently selected from methyl, ethyl, (C₃-C₆) alkyl, substituted or unsubstituted (C₃-C₇) cycloalkyl, (C₆-C₁₀) aryl, (C₆-C₁₀) aralkyl, methoxy, ethoxy, (C₃-C₆) alkoxy, substituted or unsubstituted (C₃-C₇) cycloalkoxy, (C₆-C₁₀) aryloxy and (C₆-C₁₀) aralkyloxy.

Representative examples of PR₃¹ include trimethylphosphine, triethylphosphine, tri-n-propylphosphine, tri-iso-propylphosphine, tri-n-butylphosphine, tri-iso-butylphosphine, tri-tert-butylphosphine, tricyclopentylphosphine, triallylphosphine, tricyclohexylphosphine, triphenylphosphine, trimethyl phosphite, triethyl phosphite, tri-n-propyl phosphite, tri-iso-propyl phosphite, tri-n-butyl phosphite, tri-isobutyl phosphite, tri-tert-butyl phosphite, tricyclopentyl phosphite, triallyl phosphite, tricyclohexyl phosphite, and triphenyl phosphite.

Other examples of organophosphorus compounds suitable as Lewis bases include phosphinite and phosphonite ligands. Representative examples of phosphinite ligands include methyl diphenylphosphinite, ethyl diphenylphosphinite, isopropyl diphenylphosphinite, and phenyl diphenylphosphinite. Representative examples of phosphonite ligands include diphenyl phenylphosphonite, dimethyl phenylphosphonite, diethyl methylphosphonite, diisopropyl phenylphosphonite, and diethyl phenylphosphonite.

If added, the Lewis base may typically be added in a stoichiometric excess amount, although this is not a requirement.

Exemplary activators include: lithium tetrakis(2-fluorophenyl)borate, sodium tetrakis(2-fluorophenyl)borate, silver tetrakis(2-fluorophenyl)borate, thallium tetrakis(2-fluorophenyl)borate, lithium tetrakis(3-fluorophenyl)borate, sodium tetrakis(3-fluorophenyl)borate, silver tetrakis(3-fluorophenyl)borate, thallium tetrakis(3-fluorophenyl)borate, ferrocenium tetrakis(3-fluorophenyl)borate, ferrocenium tetrakis(pentafluorophenyl)borate, lithium tetrakis(4-fluorophenyl)borate, sodium tetrakis(4-fluorophenyl)borate, silver tetrakis(4-fluorophenyl)borate, thallium tetrakis(4-fluorophenyl)borate, lithium tetrakis(3,5-difluorophenyl)borate, sodium tetrakis(3,5-difluorophenyl)borate, thallium tetrakis(3,5-difluorophenyl)borate, trityl tetrakis(3,5-difluorophenyl)borate, 2,6-dimethylanilinium tetrakis(3,5-difluorophenyl)borate, lithium tetrakis(pentafluorophenyl)borate, lithium (diethyl ether)tetrakis(pentafluorophenyl)borate, lithium (diethyl ether)tetrakis(pentafluorophenyl) borate, lithium tetrakis(2,3,4,5-tetrafluorophenyl)borate, lithium tetrakis(3,4,5,6-tetrafluorophenyl)borate, lithium tetrakis(1,2,2-trifluoroethylenyl)borate, lithium tetrakis(3,4,5-trifluorophenyl)borate, lithium methyltris(perfluorophenyl)borate, lithium phenyltris(perfluorophenyl)borate, lithium tris(isopropanol)tetrakis(pentafluorophenyl)borate, lithium tetrakis(methanol)tetrakis(pentafluorophenyl)-borate, silver tetrakis(pentafluorophenyl)borate, tris(toluene)silver tetrakis(pentafluorophenyl)borate, tris(xylene)silver tetrakis(pentafluorophenyl)borate, trityl tetrakis(pentafluorophenyl)borate, trityl tetrakis(4-triisopropylsilyltetrafluorophenyl)borate, trityl tetrakis(4-dimethyl-tert-butylsilyl-tetrafluorophenyl)borate, thallium tetrakis[3,5-bis(trifluoromethyl)phenyl]borute, 2,6-dimethylanilinium tetrakis(pentafluorophenyl)borate, N,N-dimethylanilinium tetrakis(pentafluorophenyl)borate. N,N-dimethylanilinium tetrakis[3,5-bis(trifluoromethyl)phenyl]borate, lithium (triphenylsiloxy)-tris(pentafluorophenyl)borate, sodium (triphenylsiloxy)tris(pentafluorophenyl)borate, sodium tetrakis(2,3,4,5-tetrafluorophenyl)borate, sodium tetrakis(3,4,5,6-tetrafluorophenyl)borate, sodium tetrakis(1,2,2-trifluoroethylenyl)borate, sodium tetrakis(3,4,5-trifluorophenyl)borate, sodium methyltris(perfluorophenyl)borate, sodium phenyltris(perfluorophenyl)borate, thallium tetrakis(2,3,4,5-tetrafluorophenyl)borate, thallium tetrakis(3,4,5,6-tetrafluorophenyl)borate, thallium tetrakis(1,2,2-trifluoroethylenyl)borate, thallium tetrakis(3,4,5-trifluorophenyl)borate, sodium methyltris(perfluoro-phenyl)borate, thallium phenyltris(perfluorophenyl)borate, trityl tetrakis(2,3,4,5-tetrafluorophenyl)borate, trityl tetrakis(3,4,5,6-tetrafluorophenyl)borate, trityl tetrakis(1,2,2-trifluoroethylenyl)borate, trityl tetrakis(3,4,5-trifluorophenyl)borate, trityl methyltris(pentafluorophenyl)borate, trityl phenyltris-(perfluorophenyl)borate, silver tetrakis[3,5-bis(trifluoromethyl)phenyl]borate, silver(toluene) tetrakis[3,5-bis(trifluoromethyl)phenyl]borate, thallium tetrakis[3,5-bis(trifluoromethyl)phenyl]borate, lithium hexyltris(pentafluorophenyl)borate, lithium triphenylsiloxytris(pentafluorophenyl)borate, lithium (octyloxy)tris(pentafluorophenyl)borate, lithium tetrakis(3,5-bis(trifluoromethyl)phenyl)borate, sodium tetrakis(pentafluorophenyl)borate, trityl tetrakis(pentafluorophenyl)borate, sodium (octyloxy)tris(penta-fluorophenyl)borate, sodium tetrakis(3,5-bis(trifluoroiethyl)phenyl)borate, potassium tetrakis(penta-fluorophenyl)borate, trityl tetrakis(pentafluorophenyl)borate, potassium (octyloxy)tris(pentafluoro-phenyl)borate, potassium tetrakis(3,5-bis(trifluoromuethyl)phenyl)borate, magnesium tetrakis(pentafluoro-phenyl)borate, magnesium (octyloxy)tris(pentafluorophenyl)borate, magnesium tetrakis(3,5-bis(trifluoro-methyl)phenyl)borate, calcium tetrakis(pentafluorophenyl)borate, calcium (octyloxy)tris(pentafluoro-phenyl)borate, calcium tetrakis(3,5-bis(trifluoromethyl)phenyl)borate, lithium tetrakis[3,5-bis[1-methoxy-2,2,2-trifluoro-1-trifluoromethyl)ethyl]phenyl]borate, sodium tetrakis[3,5-bis[1-methoxy-2,2,2-trifluoro-1-(trifluoromethyl)ethyl]phenyl]borate, silver tetrakis[3,5-bis[1-methoxy-2,2,2-trifluoro-I-(trifluoro-methyl)ethyl]phenyl]borate, thallium tetrakis[3,5-bis[1-methoxy-2,2,2-trifluoro-l-(trifluoromethyl)-ethyl]phenyl]borate, lithium tetrakis[3-[1-methoxy-2,2,2-trifluoro-1-(trifluoromethyl)ethyl]-5-(trifluoro-methyl)phenyl]borate, sodium tetrakis[3-[1-methoxy-2,2,2-trifluoro-1-(trifluoromethyl)ethyl]-5-(trifluoromethyl)phenyl]borate, silver tetrakis[3-[1-methoxy-2,2,2-trifluoro-1-(trifluoromethyl)ethyl]-5-(trifluoromethyl)phenyl]borate, thallium tetrakis[3-[1-methoxy-2,2,2-trifluoro-1-(trifluoromethyl)ethyl]-5-(trifluoromethyl)phenyl]borate, lithium tetrakis[3-[2,2,2-trifluoro-1-(2,2,2-trifluoroethoxy)-1-(trifluoromethyl)ethyl]-5-(trifluoromuethyl)phenyl]borate, sodium tetrakis[3-[2.2,2-trifluoro-1-(2,2,2-trifluoroethoxy)-1-(trifluoromethyl)ethyl]-5-(trifluoromuethyl)phenyl]borate, silver tetrakis [3-[2,2,2-trifluoro-1-(2,2,2-trifluoroethoxy)-1-(trifluoromethyl)ethyl]-5-(trifluoromethyl)phenyl]borate, thallium tetrakis[3-[2,2,2-trifluoro-1-(2,2,2-trifluoroethoxy)-1-(trifluoromethyl)ethyl]-5-(trifluoromethyl)-phenyl]borate, trimethylsilylium tetrakis(pentafluorophenyl)borate, trimethylsilylium etherate tetrakis-(pentafluorophenyl)borate, triethylsilylium tetrakis(pentafluorophenyl)borate, triphenylsilylium tetrakis(pentafluorophenyl)borate, tris(mesityl)silylium tetrakis(pentafluorophenyl)borate, tribenzyl-silylium tetrakis(pentafluorophenyl)borate, trimethylsilylium methyltris(pentafluorophenyl)borate, triethylsilylium methyltris(pentafluorophenyl)borate, triphenylsilylium methyltris(pentafluorophenyl)-borate, tribeuzylsilylium methyltris(pentafluorophenyl)borate, trimethylsilylium tetrakis(2,3,4,5-tetrafluorophenyl)borate, triethylsilylium tetrakis(2,3,4,5-tetrafluorophenyl)borate, triphenylsilylium tetrakis(2,3,4,5-tetrafluorophenyl)borate, tribenzylsilylium tetrakis(2,3,4,5-tetrafluorophenyl)borate, trimethylsilylium tetrakis(2,3,4,5-tetrafluorophenyl) borate, triphenylsilylium tetrakis(2,3,4,5-tetra-fluorophenyl)borate, trimethylsilylium tetrakis(3,4,5-trifluorophenyl)borate, tribenzylsilylium tetrakis(3,4,5-trifluorophenyl)aluminate, triphenylsilylium methyltris(3,4,5-trifluorophenyl) aluminate, triethylsilylium tetrakis(1,2,2-trifluoroethenyl)borate, tricyclohexylsilyliumu tetrakis(2,3,4,5-tetrafluorophenyl)borate, dimethyloctadecylsilylium tetrakis(pentafluorophenyl)borate, tris(trimethylsilyl)silylium methyltris(2,3,4,5-tetrafluorophenyl)borate, 2,2′-dimethyl-1,1′-binaphthyl-methylsilylium tetrakis(pentafluorophenyl)borate, 2,2′-dimethyl-1,1′-binaphthylmethylsilylium tetrakis(3,5-bis(trifluoromethyl)phenyl)borate, lithium tetrakis(pentafluorophenyl)aluminate, trityl tetrakis(pentafluorophenyl)aluminate, trityl (perfluorobiphenyl)fluoroaluminate, lithium (octyloxy)-tris(pentafluorophenyl)aluminate, lithium tetrakis(3,5-bis(trifluoromethyl)phenyl)aluminate, sodium tetrakis(pentafluorophenyl)aluminate, trityl tetrakis(pentafluorophenyl)aluminate, sodium (octyloxy)-tris(pentafluorophenyl)aluminate, sodium tetrakis(3,5-bis(trifluoromethyl)phenyl)aluminate, potassium tetrakis(pentafluorophenyl)aluminate, trityl tetrakis(pentafluorophenyl)aluminate, potassium (octyloxy)-tris(pentafluorophenyl)aluminate, potassium tetrakis(3,5-bis(trifluoromethyl)phenyl)aluminate, magnesium tetrakis(pentafluorophenyl)aluminate, magnesium (octyloxy)tris(pentafluorophenyl)-aluminate, magnesium tetrakis(3,5-bis(trifluoromethyl)phenyl)aluminate, calcium tetrakis(pentafluoro-phenyl)aluminate, calcium (octyloxy)tris(pentafluorophenyl)aluminate, calcium tetrakis(3,5-bis(trifluoro-methyl)phenyl)aluminate, LiB(OC(CF₃)₃)₄, LiB(OC(CF₃)₂(CH₃))₄, LiB(OC(CF₃)₂H)₄, LiB(OC(CF₃)(CH₃)H)₄, Tl(OC(CF₃)₃)₄, TIB(OC(CF₃)₂H)₄, TIB(OC(CF₃)(CH₃)H)₄, TIB(OC(CF₃)₂(CH₃))₄, (Ph₃C)B(OC(CF₃)₃)₄, (Ph₃C)B(OC(CF₃)₂(CH₃))₄, (Ph₃C)B(OC(CF₃)₂H)₄, (Ph₃C)B(OC(CF₃)(CH₃)H)₄, AgB(OC(CF₃))₄, AgB(OC(CF₃)₂H)₄, AgB(OC(CF₃)(CH₃)H)₄, LiB(O₂C₆F₄)₂, TIB(O₂C₆F₄)₂, Ag(toluene)₂B(O₂C₆F₄)₂, Ph₃CB(O₂C₆F₄)₂ LiB(OCH(CF₃)₂)₄, [Li(HOCH₃)₄]B(O₂C₆Cl₄)₂, [Li(HOCH₃)₄]B(O₂C₆F₄)₂, [Ag(toluene)₂]B(O₂C₆Cl₄)₂, LiB(O₂C₆Cl₄)₂, (LiAl(OC(CF₃)₂Ph)₄), (TlAl(OC(CF₃)₂Ph)₄), (AgAl(OC(CF₃)₂Ph)₄), (Ph₃CAl(OC(CF₃)₂Ph)₄, (LiAl(OC(CF₃)₂C₆H₄CH₃)₄), (TlAl(OC(CF₃)₂C₆H₄CH₃)₄), (AgAl(OC(CF₃)₂C₆H₄Cl₃)₄), (Ph₃CAl(OC(CF₃)₂C₆H₄CH₃)₄), LiAl(OC(CF₃))₄, TlAl(OC(CF₃)₃)₄, AgAl(OC(CF₃)₃)₄, Ph₃CAl(OC(CF₃)₃)₄, LiAl(OC(CF₃)(CH₃)H)₄, TlAl(OC(CF₃)(CH₃)H)₄, AgAl(OC(CF₃)(CH₃)H)₄, Ph₃CAl(OC(CF₃)(CH₃)H)₄, LiAl(OC(CF₃)₂H)₄. TlAl(OC(CF₃)₂H)₄, AgAl(OC(CF₃)₂H)₄, Ph₃CAI(OC(CF₃)₂H)₄, LiAl(OC(CF₃)₂C₆H₄-4-i-Pr)₄, TlAl(OC(CF₃)₂C₆H₄-4-i-Pr)₄, AgAl(OC(CF₃)₂C₆H₄-i-Pr)₄, Ph₃CAl(OC(CF₃)₂C₆H₄-4-i-Pr)₄, LiAl(OC(CF₃)₂C₆H₄-t-butyl)₄, TlAl(OC(CF₃)₂C₆H₄-t-butyl)₄, AgAl(OC(CF₃)₂C₆H₄-4-t-butyl)₄, LiA](OC(CF₃)₂C₆H₄-4-SiMe₃)₄. TlAl(OC(CF₃)₂C₆H₄-4-SiMe₃)₄, AgAl(OC(CF₃)₂C₆H₄-4-SiMe₃)₄, Ph₃CA](OC(CF₃)₂C₆H₄-4-SiMe₃)₄, LiAl(OC(CF₃)₂C₆H₄-4-Si-i-Pr₃)₄, TlAl(OC(CF₃)₂C₆H₄-4-Si-i-Pr₃)₄, AgAl(OC(CF₃)₂C₆H₄-4-Si-i-Pr₃)₄, Ph₃ CA](OC(CF₃)₂C₆H₄-4-Si-i-Pr₃)₄, LiAl(OC(CF₃)₂C₆H₂-2,6-(CF₃)₂-4-Si-i-Pr₃)₄, TlAl(OC(CF₃)₂C₆H₂-2,6-(CF₃)₂-4-Si-i-Pr₃)₄, AgAl(OC(CF₃)₂C₆H₂-2,6-(CF₃)₂-4-Si-i-Pr₃)₄, Ph₃CAl(OC(CF₃)₂C₆H₂-2,6-(CF₃)₂-4-Si-i-Pr₃)₄, LiAl(OC(CF₃)₂C₆H₃-3,5-(CF₃)₂)₄, TlAl(OC(CF₃)₂C₆H₃-3,5-(CF₃)₂)₄, AgAl(OC(CF₃)₂C₆H₃-3,5-(CF₃)₂)₄, Ph₃CAl(OC(CF₃)₂C₆H₃- 3,5-(CF₃)₂)₄, LiAl(OC(CF₃)₂C₆H₂-2,4,6-(CF₃))₄, TlAl(OC(CF₃)₂C₆H₂-2,4,6-(CF₃)₃)₄, AgAl(OC(CF₃)₂C₆H₂-2,4,6-(CF₃)₃)₄, Ph₃CAl(OC(CF₃)₂C₆H₂-2,4,6-(CF₃L)₄, LiAl(OC(CF₃)₂C₆F₅)₄, TlAl(OC(CF₃)₂C₆F₅)₄, AgAl(OC(CF₃)₂C₆F₅)₄, Ph₃CAl(OC(CF₃)₂C₆F₅)₄, [1,4-dihydro-4-methyl-I-(pentafluorophenyl)]-2-borinyl lithium, [1,4-dihydro-4-methyl-1-(pentafluorophenyl)]-2-borinyl triphenylmethylium, 4-(1,1-dimethyl)-1,2-dihydro-1-(pentafluorophenyl)-2-borinyllithium, 4-(1,1-dimethyl)-1,2-dihydro-1-(pentafluorophenyl)-2-borinyltriphenylmethylium, 1-fluoro-1,2-dihydro-4-(pentafluorophenyl)-2-borinyllithium, 1-fluoro-1,2-dihydro-4-pentafluorophenyl)-2-borinyl triphenylmethylium, 1-[3,5-bis(trifluoromethyl)phenyl]-1,2-dihydro-4-(pentafluorophenyl)-2-borinyl lithium, and 1-[3,5-bis(trifluoromethyl)phenyl]-1,2-dihydro-4-(pentafluorophenyl)-2-borinyl triphenylmethylium.

Typically, the molar ratio of activator to procatalyst is in the range of 10:1 to 1:10, preferably 10:1 to 1:1, although other ratios may also be used.

Many useful addition polymerization catalysts and procatalyst/activator combinations are known and are disclosed, for example, in col. 8, line 28 to col. 9 line 56 of U.S. Pat. No. 3,330,815 (McKeon et al.); col. 3, line 9 to col. 17, line 16 of U.S. Pat. No. 6,455,650 B1 (Lipian et al.); col. 3, line 18 to col. 31, line 53 of U.S. Pat. No. 6,825,307 (Goodall); col. 3, line 31 to col. 17, line 16 of U.S. Pat. No. 6,903,171 B2 (Rhodes et al.); and col. 16, line 32 to col. 28, line 31 of U.S. Pat. No. 7,759,439 B2 (Rhodes et al.); col. 20, line 28 to col. 21, line 30 in U.S. Pat. No. 10,266,720 (Burgoon et al.); and paragraphs [0015] to [0075] of U. S. Pat. Appl. Publ. 2005/0187398 A1 (Bell et al.), the disclosures of which are incorporated herein by reference. Another category of catalysts involves procatalyst complexes of early or late metals that do not initially have alkyl/allyl ligands but are alkylated by a cocatalyst such as, for example, methylaluminoxane.

Details concerning certain addition polymerization catalysts are also reported by M. V. Bermeshev and P. P. Chapala in “Addition polymerization of functionalized norbornenes as a powerful tool for assembling molecular moieties of new polymers with versatile properties”, Progress in Polymer Science (2018), 84, pp. 1-46.

The addition polymerization catalyst may be included in any effective amount to cause at least partial curing of the curable composition, optionally with heating. Typically, the amount of addition polymerization catalyst can vary from about 0.0001 part by weight to about 20 parts by weight based on 100 parts by weight of the addition polymerizable compounds that are present in the curable composition, preferably from about 0.01 part by weight to about 5 parts by weight per 100 parts by weight of the addition polymerizable compounds that are present in the curable composition; however this is not a requirement.

Curable compositions according to the present disclosure include at least one of hollow glass microspheres, expanded polymeric microspheres, or expandable polymeric microspheres. If including expandable polymeric microspheres in the curable composition, they should be heated to sufficient temperature before or during curing that they become expanded polymeric microspheres. Accordingly, at least partially cured compositions according to the present disclosure preferably include at least one of hollow glass microspheres or expanded polymeric microspheres.

Expandable polymeric microspheres are commercially available in various unexpanded average particle sizes, for example, in the range of 6 to 9 microns, in the range of 9 to 15 microns, in the range of 10 to 16 microns, in the range of 18 to 24 microns, in the range of 35 to 45 microns, and in the range of 28 to 38 microns. Some of the unexpanded particle size ranges are also available in more than one type of material.

Expandable polymeric microspheres typically encapsulate a propellant that is a liquid at room temperature and has a boiling point at atmospheric pressure below the softening point of the shell material. The propellant expands when heated causing expansion of the outer shell of the polymeric microspheres. For example, the polymeric microspheres can include a liquid or gas selected from isooctane, (2,2,4-trimethyl pentane), butanes, pentanes, hexanes, heptanes, petroleum distillates, or other liquids with a suitable boiling point or boiling point range or combinations thereof. In an embodiment, hydrocarbons such as isobutane, isopentane, n-pentane, n-hexane, petroleum ether or n-heptane can be utilized alone or in combination with isooctane.

Exemplary polymeric microspheres include those commercially available under the trade designation EXPANCEL from Nouryon, Amsterdam. The Netherlands. Details regarding EXPANCEL microspheres can be found in U.S. Pat. No. 6,509,384 (Bjerke et al.). They are available in various forms such as unexpanded and in a solvent (EXPANCEL WU), unexpanded and dry (i.e., no solvent present) (EXPANCEL DU), expanded and in a solvent (EXPANCEL WE), or expanded and dry (EXPANCEL DE).

Exemplary EXPANCEL WU microspheres include EXPANCEL 551 WU 40 (D₅₀=9-15 microns), EXPANCEL 461 WU 20 (D₅₀=6-9 microns), EXPANCEL 461 WU 40 (D₅₀=9-15 microns), EXPANCEL 551 WU 40 (D₅₀=9-15 microns), EXPANCEL 053 WU 40 (D₅₀=10-16 microns), EXPANCEL 909 WU 80 (D₅₀=18-24 microns), EXPANCEL 920 WUF 80 (D₅₀=10-16 microns). Exemplary EXPANCEL DU microspheres include EXPANCEL 551 DU 40 (D₅₀=9-15 microns); EXPANCEL 461 DU 20 (D₅₀=6-9 microns); EXPANCEL 461 DU 40 (D₅₀=9-15 microns); EXPANCEL 051 DU 40 (D₅₀=9-15 microns); EXPANCEL 053 DU 40 (D₅₀=10-16 microns); EXPANCEL 093 DU 120 (D₅₀=28-38 microns); EXPANCEL 909 DU 80 (D₅₀=18-24 microns); EXPANCEL 920 DU 80 (D₅₀=18-24 microns); EXPANCEL 920 DU 120 (D₅₀=28-38 microns); EXPANCEL 930 DU 120 (D₅₀=28-38 microns); EXPANCEL 920 DU 40 (D₅₀=10-16 microns); EXPANCEL 930 DU 120 (D₅₀=28-38 microns); EXPANCEL 950 DU 80 (D₅₀=18-24 microns); and EXPANCEL 980 DU 120 (D₅₀=25-40 microns). EXPANCEL WE grades include EXPANCEL 461 WE 20 d36 (D₅₀=20-30 microns), EXPANCEL 461 WE 40 d36 (D₅₀=30-50 microns), and EXPANCEL 921 WE 40 d24 (D₅₀=35-55 microns). EXPANCEL DE grades include EXPANCEL 551 DE 40 d42 (D₅₀=25-50 microns), EXPANCEL 461 DE 20 d70 (D₅₀=15-25 microns), EXPANCEL 461 DE 40 d60 (D₅₀=20-40 microns), EXPANCEL 461 DET 40 d25 (D₅₀=35-55 microns), EXPANCEL 920 DE 40 d30 (D₅₀=35-55 microns), EXPANCEL 920 DET 40 d25 (D₅₀=30-60 microns), EXPANCEL 920 DE 80 d30 (D₅₀=55-85 microns), and EXPANCEL 043 DET 80 d20 (D₅₀ =60-95 microns).

In other embodiments, hollow glass microspheres can also be utilized. Hollow glass microspheres can be fabricated as discussed in U.S. Pat. No. 3,365,315 (Beck); U.S. Pat. No. 4,391,646 (Howell); and 4,618,525 (Chamberlain et al.). Such exemplary hollow glass microspheres have a shell material that includes a glass. In an embodiment, the shell material may include SiO₂, Na₂O, CaO, K₂O, Li₂O, BaO, MgO, SrO, ZnO, PbO, TiO₂, MnO₂, ZrO₂, B₂O₃, Al₂O₃, Fe₂O3, Sb₂O₃, P₂O₅, V₂O₅, or combinations thereof for example. In an embodiment, the shell material includes a majority (by weight) of SiO₂ and optionally other components. Hollow glass microspheres can contain various different gases within the glass shell material. Exemplary gases include H₂O, CO₂, SO₂, SO₃, F₂, N₂, O₂, or mixtures thereof.

Commercially available hollow glass microspheres (also variously known as glass bubbles, glass microbubbles, and glass microballoons) include those available from 3M Company, Maplewood, Minnesota under the trade designation 3M GLASS BUBBLES in grades K37 (D₅₀=45 microns), S38 (D₅₀=40 microns), S38HS (D₅₀=40 microns), K42HS (D50=22 microns), S60 (D50=30 microns), S60HS (D₅₀=30 microns), and iM30K (D₅₀=16 microns).

In some preferred embodiments, the size of hollow glass microspheres and/or expanded polymeric microspheres is from one to 200 microns, more preferably 5 to 100 microns, and more preferably 10 to 85 microns, although this is not a requirement.

The total amount of hollow glass microspheres, expanded polymeric microspheres, and expandable polymeric microspheres in the curable composition may range, for example, from 1 to 50 percent by weight, preferably 5 to 30 percent by weight, based on the total weight of the curable and/or at least partially cured composition, although other amounts may also be used.

Curable compositions according to the present disclosure may be provided as one-part or two-part curable compositions. Two-part curable compositions are kept separate (e.g., to provide extended storage stability) and are typically combined immediately prior to use. Typically, two-part compositions will comprise a Part A composition and a Part B composition. In typical embodiments Part A may comprise a procatalyst and Part B may comprise an activator, or vice versa. The remaining components of the curable composition are distributed in any suitable manner between the two parts, optionally dissolved in a liquid vehicle such as solvent or plasticizer). In another embodiment, an addition polymerizable catalyst is supplied in a Part B (e.g., dissolved in a liquid vehicle such as, for example, solvent or plasticizer) while Part A includes at least the addition polymerizable components.

The relative volumes of each part may be in any ratio; however, a ratio of Part A to Part B of 10:1 to 1:10 is typically preferred.

Curable compositions according to the present disclosure may include one or more polymeric tougheners. Polymeric tougheners typically have a relatively lower glass transition temperature than the other polymer components when cured. Typically, they are rubbery materials. Exemplary tougheners include ethylene propylene rubber (EPR), ethylene propylene diene monomer rubber (EPDM), and styrene-containing elastomers. Preferred styrene-containing elastomers include styrene-butadiene-styrene (SBS) elastomer, styrene-ethylene-butadiene-styrene (SEBS) elastomer, styrene-ethylene-propylene-styrene (SEP) elastomer and combinations thereof. Many such elastomers are commercially available such as, for example, KRATON elastomers from Shell Chemical Company, Houston, Texas and SEPTON brand elastomers from Kuraray Co., Tokyo, Japan. Variations are also available containing various amount of styrene in the elastomer. Elastomers containing different amounts of the monomers, e.g., styrene, may also be prepared by well known processes such as, for example, blending different elastomers in suitable proportions to arrive at a new elastomeric composition containing a monomer ratio different from the starting materials. Such variations offer unique advantages in the present disclosure, by improving the impact strength without significantly affecting the optical properties, making these blends uniquely suitable for applications where such properties are desired and needed.

The amount of polymeric tougheners may range, for example, from 0.1 to 30 percent by weight, preferably 1 to 20 percent by weight, based on the total weight of the curable and/or at least partially cured composition, though other amounts may also be used.

While in many cases the curable composition can be solvent-free, in some cases it may be advantageous to include solvent, typically in a minor amount although this is not a requirement. For example, such use of small amounts of solvent may be used to dissolve the procatalyst and/or the activator in a two-part curable composition or convey the same to the curable composition whether one or two part. Also, some solvent may be used to reduce the viscosity of the monomer. For example, the amount of solvent that can be used in the reaction medium may be in the range of 0 to 50 weight percent, preferably 0 to 20 percent, based on the total weight of the addition polymerization compounds present. Any of the suitable solvents that dissolves the catalyst, activator and/or monomers can be employed in this present disclosure. Examples of such solvents include alkanes, cycloalkane, toluene, tetrahydrofuran, methylene chloride, and dichloroethane. Generally, it is advantageous to use a solvent having a boiling point lower than the polymerization temperature, such as for example 100° C. or less; 120° C. or less; or 150° C. or less.

Additional non-interfering components may also be included in curable compositions according to the present disclosure including fillers, inorganic and/or organic fibers, polymeric tougheners, plasticizers, adhesion promoters, fibers, antioxidants, UV light absorbers, colorants, and fragrances. Such components should generally be selected such that they do not substantially adversely affect the addition polymerization catalyst activity.

Exemplary fillers include silica (e.g., fumed silica), alumina (e.g., alpha alumina), zirconia, carbon black, titania, zircoaluminate, and combinations thereof. Combinations of fillers may be used. Typical amounts may be up to 10 volume percent, 20 volume percent, 30 volume percent, 40 volume percent, or even up to 50 volume percent, although this is not a requirement.

Exemplary plasticizers include esters such as dioctyl phthalate (i.e., di(ethylhexyl) phthalate), dioctyl sebacate, butyl oleate, and aromatic and paraffinic oils (e.g., mineral oil). Combinations of plasticizers may be used. The amount of plasticizer will be dictated by the target glass transition temperature (T_{g}) of the at least partially cured composition, with higher amounts leading to lower values of T_{g}.

Adhesion promoters improve bonding to certain substrates, and may vary depending on the substrate. Examples of suitable adhesion promoters include functionalized styrene-ethylene-butylene-styrene (SEBS) polymer (e.g., as Kraton MD1648 from Kraton Corp., Houston, Texas), functionalized polybutadiene, functionalized ethylene vinyl acetate copolymers (e.g., random terpolymers of ethylene, vinyl acetate and maleic anhydride marketed as OREVAC 18211, OREVAC T 9304, OREVAC T 9305, OREVAC T 9307 Y, OREVAC T 9309, OREVAC T 9314, and OREVAC T 9318 from SK Functional Polymer, Paris, France), and maleated polyethylene and maleated waxes. In some preferred embodiments, the adhesion promoters are polymers such as for, example, a polypropylene having with grafted maleic anhydride groups (e.g., as available as EPOLENE in grades G-3003, G-3015, and G-3003 from Eastman Chemical Co., Kingsport, Tennessee), epoxy groups, and/or silyl groups.

Curable compositions according to the present disclosure can be at least partially cured, preferably at least to the point that they are not fluid at 25° C., to provide composite foams having a polymer matrix containing glass bubbles and/or expanded polymeric microspheres. Typically, the composite foam comprises up to 50 weight percent of hollow glass beads or expanded polymeric microspheres, corresponding to their fraction amount of the nonvolatile components in the curable composition. In this regard, unexpanded polymeric microspheres and expanded polymeric microspheres in the curable composition are to be considered as one, since they both are present as expanded microspheres in the composite foam.

Depending on the selection of the curable composition, as discussed hereinabove, the polymer matrix may be crosslinked or not crosslinked. In preferred embodiments, composite foams according to the present disclosure are free of vulcanizing agents (e.g., sulfur and sulfur-containing vulcanizing agents and/or peroxides).

In embodiments wherein the polymer matrix is not crosslinked, the polymerization may be at least partially carried out before the glass bubbles/expanded polymeric microspheres/and/or expandable polymer microspheres are added. In such cases, a liquid vehicle such as, for example, solvent is preferably included to reduce mixing viscosity.

Composite foams according to the present disclosure may have an average cell size (i.e., pore size) in a range from 10 to 3000 (in some embodiments, 10 to 2000, 10 to 1000, 10 to 500, or even 10 to 100) micrometers, although other cell sizes are also permitted. In some embodiments, composite foams according to the present disclosure have a total porosity of at least 5 (in some embodiments, at least 10, 20, 25, 30, 40, 50, 60, or even at least 70 volume percent; in some embodiments, in a range from 10 to 70, 10 to 60, or even 10 to 50) volume percent, based on the total volume of the composite foam.

The polymer matrix may have any T_{g}, for example, in a range of from −50° C. to 350° C., although other values are also permissible. In some preferred embodiments, the polymer matrix has a T_{g} of at least 100° C., at least 110° C., at least 120° C., at least 130° C., or even at least 140° C.

Composite foams according to the present disclosure can be prepared, for example, by heating a curable composition according to the present disclosure for sufficient time and at sufficient temperature to result in at least partial curing, preferably substantially full curing, of the curable composition and, if present, expansion of unexpanded polymeric microspheres. The heating temperature will depend on the specific curable composition and may be at least 50° C., at least 75° C., at least 100° C., or at least 150° C., for example. In the case of two-part curable compositions reaction may be spontaneous and no heating is necessary.

In some preferred embodiments, the composite foam has a dielectric constant of less than or equal to 3.0, less than or equal to 2.5, less than or equal to 2.2, or even less than or equal to 2.0; however, this is not a requirement.

Composite foams according to the present disclosure may have the form of a freestanding film or they may be useful as a gap filling material that is disposed into the gap as a curable composition according to the present disclosure and cured in place to form the composite foam.

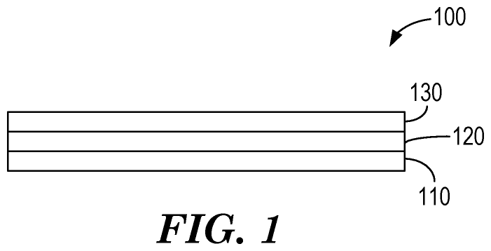

Referring now to FIG. 1, exemplary article 100 comprises a first substrate 110 in contact with composite foam 120 according to the present disclosure. If optional second substrate 130 is present, composite foam 120 is sandwiched between first and second substrates 110, 130.

The first and/or second substrates may comprise any solid material. Examples include metals (e.g., aluminum, copper, silver, gold, and alloys thereof), ceramics (e.g., alumina, zirconia, porcelain, sapphire), glass, plastics (e.g., polycarbonate, polyimide, polyetheretherketone, polyetherketone, polypropylene, polyethylene, and polymethyl methacrylate), thermosets (polyurethanes, phenolics, and acrylics), and combinations thereof.

In some preferred embodiments, the first and optional second substrates are component(s) of an electronic device, preferably one that communicates at a 5G frequency such as, for example, a cell phone, a cell tower, a smart television, or a tablet computer.

### Select Embodiments of the Present Disclosure

In a first embodiment, the present disclosure provides a curable composition comprising:
an addition polymerizable cycloolefin comprising a ring containing a single carbon-carbon double bond;
an addition polymerization catalyst; and
at least one of hollow glass microspheres, expanded polymeric microspheres, or expandable polymeric microspheres.

In a second embodiment, the present disclosure provides a curable composition according to the first embodiment wherein the addition polymerization catalyst comprises at least one of palladium or nickel.

In a third embodiment, the present disclosure provides a curable composition according to the first or second embodiment, wherein the addition polymerizable cycloolefin is represented by the formula

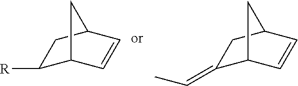

or a stereoisomer thereof, wherein R represents H or an alkyl group having up to ten carbon atoms.

In a fourth embodiment, the present disclosure provides a curable composition according to any of the first to third embodiments, wherein the curable composition comprises the hollow glass microspheres.

In a fifth embodiment, the present disclosure provides a curable composition according to any of the first to fourth embodiments, wherein the curable composition comprises the expandable or expanded polymeric microspheres.

In a sixth embodiment, the present disclosure provides a curable composition according to any of the first to fifth embodiments, further comprising an elastomeric toughener.

In a seventh embodiment, the present disclosure provides a curable composition according to any of the first to sixth embodiments, further comprising a cycloolefin crosslinker having at least two non-conjugated carbon-carbon double bonds that are polymerizable by addition polymerization.

In an eighth embodiment, the present disclosure provides a curable composition according to any of the first to seventh embodiments, wherein the addition polymerizable cycloolefin is represented by the formula

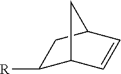

or a stereoisomer thereof, wherein R represents H or an alkyl group having up to ten carbon atoms.

In a ninth embodiment, the present disclosure provides a curable composition according to the eighth embodiment, wherein R represents an alkyl group having up to four carbon atoms.

In a tenth embodiment, the present disclosure provides a curable composition according to any of the first to seventh embodiments, wherein the addition polymerizable cycloolefin is represented by the formula

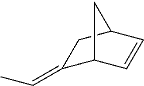

or a stereoisomer thereof.

In an eleventh embodiment, the present disclosure provides a curable composition according to any of the first to tenth embodiments, further comprising a plasticizer.

In a twelfth embodiment, the present disclosure provides a two-part curable composition comprising:
a Part A comprising
   a first liquid vehicle;
   a procatalyst; and
a Part B comprising
   a second liquid vehicle, and
   an activator that when combined with the procatalyst generates an addition polymerization catalyst,
wherein at least one of the first or second liquid vehicle comprises an addition polymerizable cycloolefin comprising a ring containing a single carbon-carbon double bond, and
wherein at least one of the Part A or Part B further comprises at least one of hollow glass microspheres, expanded polymeric microspheres, or expandable polymeric microspheres.

In a thirteenth embodiment, the present disclosure provides a two-part curable composition according to the twelfth embodiment, wherein the procatalyst comprises at least one of palladium or nickel.

In a fourteenth embodiment, the present disclosure provides a two-part curable composition according to the twelfth or thirteenth embodiment, wherein at least one of the first or second addition polymerizable cycloolefins is represented by the formula

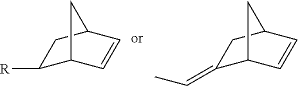

or a stereoisomer thereof, wherein R represents H or an alkyl group having up to ten carbon atoms.

In a fifteenth embodiment, the present disclosure provides a two-part curable composition according to any of the twelfth to fourteenth embodiments, wherein at least one of the Part A or the Part B further comprises an elastomeric toughener.

In a sixteenth embodiment, the present disclosure provides a two-part curable composition according to any of the twelfth to fifteenth embodiments, wherein at least one of the first or second addition polymerizable cycloolefins has at least two non-conjugated carbon-carbon double bonds that are polymerizable by addition polymerization.

In a seventeenth embodiment, the present disclosure provides a two-part curable composition according to any of the twelfth to sixteenth embodiments, wherein at least one of the first or second addition polymerizable cycloolefins is represented by the formula

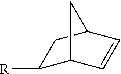

or stereoisomer thereof, wherein R represents H or an alkyl group having up to ten carbon atoms.

In an eighteenth embodiment, the present disclosure provides a two-part curable composition according to the seventeenth embodiment, wherein R represents an alkyl group having up to four carbon atoms.

In a nineteenth embodiment, the present disclosure provides a two-part curable composition according to any of the twelfth to sixteenth embodiments, wherein at least one of the first or second addition polymerizable cycloolefins is represented by the formula

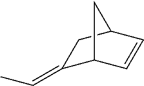

or a stereoisomer thereof.

In a twentieth embodiment, the present disclosure provides a two-part curable composition according to any of the twelfth to nineteenth embodiments, wherein at least one of the Part A or the Part B further comprises a plasticizer.

In a twenty-first embodiment, the present disclosure provides a composite foam comprising:
a polymer matrix made by addition polymerization of at least one cycloolefin comprising a ring containing a single carbon-carbon double bond;
an addition polymerization catalyst; and
at least one of hollow glass microspheres or expanded polymeric microspheres.

In a twenty-second embodiment, the present disclosure provides a composite foam according to the twenty-first embodiment, wherein the polymer matrix is not crosslinked.

In a twenty-third embodiment, the present disclosure provides a composite foam according to the twenty-first embodiment, wherein the polymer matrix is crosslinked.

In a twenty-fourth embodiment, the present disclosure provides a composite foam according to any of the twenty-first to twenty-third embodiments, wherein the composite foam is free of vulcanizing agent.

In a twenty-fifth embodiment, the present disclosure provides a composite foam according to any of the twenty-first to twenty-fourth embodiments, further comprising an elastomeric toughener that is mechanically blended with the polymer matrix.

In a twenty-sixth embodiment, the present disclosure provides a composite foam according to any of the twenty-first to twenty-fifth embodiments, wherein the polymer matrix has a glass transition temperature of at least 100° C.

In a twenty-seventh embodiment, the present disclosure provides a composite foam according to any of the twenty-first to twenty-sixth embodiments, wherein at least one of the at least one cycloolefin is represented by the formula

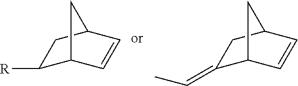

or a stereoisomer thereof, wherein R represents H or an alkyl group having up to ten carbon atoms.

In a twenty-eighth embodiment, the present disclosure provides a composite foam according to any of the twenty-first to twenty-sixth embodiments, wherein at least one of the at least one cycloolefin is represented by the formula

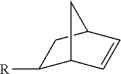

or a stereoisomer thereof, wherein R represents H or an alkyl group having up to ten carbon atoms.

In a twenty-ninth embodiment, the present disclosure provides a composite foam according to the twenty-eighth embodiment, wherein R represents an alkyl group having up to four carbon atoms.

In a thirtieth embodiment, the present disclosure provides a composite foam according to any of the twenty-first to twenty-seventh embodiments, wherein at least one of the at least one cycloolefin is represented by the formula

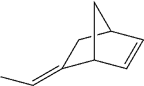

or a stereoisomer thereof.

In a thirty-first embodiment, the present disclosure provides a composite foam according to any of the twenty-first to thirtieth embodiments, further comprising a plasticizer.

In a thirty-second embodiment, the present disclosure provides a composite foam according to any of the twenty-first to thirty-first embodiments, wherein the composite foam has a dielectric constant of less than or equal to 2.5.

In a thirty-third embodiment, the present disclosure provides an article comprising a first substrate in contact with a composite foam of according to any of the twenty-first to thirty-second embodiments.

In a thirty-fourth embodiment, the present disclosure provides an article according to the thirty-third embodiment, wherein the composite foam is disposed between and contacts the first substrate and a second substrate.

In a thirty-fifth embodiment, the present disclosure provides an article according to the thirty-third or thirty-fourth embodiment, wherein the first substrate comprises at least one of copper or silver.

In a thirty-sixth embodiment, the present disclosure provides a method comprising:
providing a curable composition comprising an addition polymerizable cycloolefin comprising a ring containing a single carbon-carbon double bond;
   an addition polymerization catalyst; and
   at least one of hollow glass microspheres, expanded polymeric microspheres, or expandable polymeric microspheres; and
heating the curable composition to provide a composite foam according to any of the twenty-first to thirty second embodiments.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight. Unless otherwise indicated, all other reagents were obtained, or are available from fine chemical vendors such as Sigma-Aldrich Company, St. Louis, Missouri, or may be synthesized by known methods. Table 1 (below) reports materials used in the examples and their sources.

TABLE 1

| DESIGNATION | DESCRIPTION | SOURCE |
|---|---|---|
| Pd Cat. | Allyl[1,3-bis(2,6- | Sigma Aldrich, St. |
| | diisopropylphenyl)imidazol-2- | Louis, Missouri |
| | ylidene]chloropalladium(II) | |
| NaBARF | Sodium tetrakis[3,5- | Sigma Aldrich |
| | bis(trifluoromethyl)phenyl]borate | |
| PCy3 | Tricyclohexylphosphine | Sigma Aldrich |
| ENB | Ethylidene norbornene | Alfa Aesar, |
| | | Haverhill, |
| | | Massachusetts |
| DNB | Decyl-norbornene (5- | Wiley Companies, |
| | decylbicyclo[2.2.1]hept-2-ene) | Coshocton, Ohio |
| NB | Norbornene | Alfa Aesar |
| EM | Expandable microspheres, | Nouryon, |
| | obtained under | Amsterdam, |
| | the trade designation | The Netherlands |
| | EXPANCEL 461 DU 20 | |
| GB | Glass bubbles, obtained | 3M Company |
| | as 3M GLASS | |
| | BUBBLES S32HS | |
| DCE | 1,2-dichloroethane | Sigma Aldrich |

Test Methods

Dynamic Mechanical Analysis (Dma) Test Method

A Q800 DMA from TA Instruments (New Castle, Delaware) was used for dynamic mechanic analysis measurements. Samples were run at a frequency of 1 Hz, strain of 0.05%, a temperature scan of 2° C./minute from 0 to 400° C. The result from the first scan was used. The glass transition temperature (T_{g}) and heat deflection temperature are reported in Table 2.

Dielectric Measurement Test Method

The dielectric constant (Dk) and loss tangent (Df) were measured according to IEC 61189-2-721:2015. The tests were performed at 9.5 GHz.

### EXAMPLES

Catalyst Solution Preparation

The addition polymerization catalyst solution was prepared by dissolving 14 milligrams (mg) of Pd Cat., 104 mg of NaBARF, and 13 mg of PCy3 in 25 grams (g) of DCE. The mixture was allowed to sit at room temperature overnight and filtered through a 0.45 micrometer (um) PTFE syringe filter before use.

### Example 1

PolyENB Film Preparation

The catalyst solution prepared above (0.9 g) was added to 9 g of ENB and mixed well. The mixture was allowed to sit at room temperature for 2 minutes to build up viscosity for coating the material onto a liner. Using a box coater with a gap of 30 mils (0.76 mm), the solution was coated onto a PET liner. The coated film was allowed to sit at room temperature for 5 minutes. The film was placed into a 150° C. oven to cure for 45 minutes and then into a 200° C. oven to cure for 1 hour to yield a clear, flexible film. Some shrinkage was observed, potentially due to the evaporation of the solvent dichloroethane.

### Example 2

PolyDNB Filmpreparation

The catalyst solution prepared above (0.9 g) was added to 9 g of DNB and mixed well. The mixture was allowed to sit at room temperature for 5 minutes to build up viscosity for coating the material onto a liner. Using a box coater with a gap of 30 mils (0.76 mm), the solution was coated onto a PET liner. The coated film was allowed to sit at room temperature for 5 minutes. The film was placed into a 150° C. oven to cure for 45 minutes and then into a 200° C. oven to cure for 1 hour to yield a clear, flexible film. Some shrinkage was observed, potentially due to the evaporation of the solvent dichloroethane.

### Example 3

PolyENB/Expandable Microsphere Film Preparation

Expandable microspheres (EM, 0.5 g), ENB (12 g), and 0.78 g of the catalyst solution were mixed. After 2 minutes, the mixture was poured onto a glass plate with 0.4 millimeter (mm) thick rubber spacers on the edges. The poured solution was placed in a fume hood for 2 minutes as the solvent evaporated. Then another glass plate of the same size was placed on top of the poured mixture. Paper clamps were used to secure the top and bottom glass plates. The secured plates containing the poured solution was then put into a 150° C. oven for 30 minutes to yield a white film. Afterwards, the secured plates were removed from the oven to cool to room temperature before the glass plates were removed and the film released from the substrates. The resulting film was flexible and exhibited a heat deflection temperature of approximately 300° C.

### Example 4

PolyENB/Glass Bubbles Film Preparation

Glass bubbles (GB, 2.0 g), ENB (8 g), and 0.52 g of the catalyst solution were mixed. After 2 minutes, the mixture was poured onto a glass plate with 0.4 mm thick rubber spacers on the edges. The poured solution was placed in a fume hood for 2 minutes as the solvent evaporated. Then another glass plate of the same size was placed on top of the poured mixture. Paper clamps were used to secure the top and bottom glass plates. The secured plates containing the poured solution was then put into a 150° C. oven for 30 minutes. Afterwards, the secured plates were removed from the oven to cool to room temperature before glass plates were removed and the film released from the substrates. The film was much harder than the films prepared with the expandable microspheres and exhibited minimal flex before breaking.

### Example 5

PolyDNB/Glass Bubbles Filmpreparation

Glass bubbles (GB, 1.5 g), DNB (6.0 g) and 0.52 g of the catalyst solution were mixed. After 15 minutes, the mixture was poured onto a glass plate with 0.4 mm thick rubber spacers on the edges. The poured solution was placed in a fume hood for 2 minutes as the solvent evaporated. Then another glass plate of the same size was placed on top of the poured mixture. Paper clamps were used to secure the top and bottom glass plates. The secured plates containing the poured solution was then put into a 90° C. oven for 1 hour and a 200° C. oven for 1 hour. Afterwards, the secured plates were removed from the oven to cool to room temperature before glass plates were removed and the film released from the substrates.

### Example 6

Poly(DNB/NB)/Glass Bubbles Film Preparation

Glass bubbles (GB, 1.5 g), NB (1.2 g), DNB (4.8 g) and 0.52 g of the catalyst solution were mixed. After 5 minutes, the mixture was poured onto a glass plate with 0.4 mm thick rubber spacers on the edges. The poured solution was placed in a fume hood for 2 minutes as the solvent evaporated. Then another glass plate of the same size was placed on top of the poured mixture. Paper clamps were used to secure the top and bottom glass plates. The secured plates containing the poured solution was then put into a 90° C. oven for 1 hour and a 200° C. oven for 1 hour. Afterwards, the secured plates were removed from the oven to cool to room temperature before glass plates were removed and the film released from the substrates.

TABLE 2

| | | | HEAT | | |
|---|---|---|---|---|---|
| | | | DEFLECTION | | |
| EXAM- | | Tg, | TEMPERATURE, | | |
| PLE | FILM | ° C. | ° C. | Dk | Df |
| EX-1 | PolyENB | 338 | | 2.37 | 0.0018 |
| EX-2 | PolyDNB | 240 | | 2.27 | 0.0005 |
| EX-3 | PolyENB/EM | | 300 | 2.31 | 0.0041 |
| EX-4 | PolyENB/GB | | | 1.98 | 0.005 |
| EX-5 | PolyDNB/GB | | | 1.84 | 0.0018 |
| EX-6 | Poly(DNB/NB)/GB | | | 1.81 | 0.0039 |

The preceding description, given in order to enable one of ordinary skill in the art to practice the claimed disclosure, is not to be construed as limiting the scope of the disclosure, which is defined by the claims and all equivalents thereto.

What is claimed is:

1. A curable composition comprising:
an addition polymerizable cycloolefin comprising a ring containing a single carbon-carbon double bond;
an addition polymerization catalyst; and
at least one of hollow glass microspheres, expanded polymeric microspheres, or expandable polymeric microspheres.

2. The curable composition of claim 1, wherein the addition polymerization catalyst comprises at least one of palladium or nickel.

3. The curable composition of claim 1, wherein the addition polymerizable cycloolefin is represented by the formula 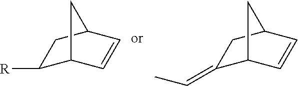
or a stereoisomer thereof, wherein R represents H or an alkyl group having up to ten carbon atoms.

4. The curable composition of claim 1, further comprising an elastomeric toughener.

5. The curable composition of claim 1, further comprising a cycloolefin crosslinker having at least two non-conjugated carbon-carbon double bonds that are polymerizable by addition polymerization.

6. The curable composition of claim 1, further comprising a plasticizer.

7. A two-part curable composition comprising:
a Part A comprising
a first liquid vehicle;
a procatalyst; and
a Part B comprising
a second liquid vehicle, and
an activator that when combined with the procatalyst generates an addition polymerization catalyst,
wherein at least one of the first or second liquid vehicle comprises an addition polymerizable cycloolefin comprising a ring containing a single carbon-carbon double bond, and
wherein at least one of the Part A or Part B further comprises at least one of hollow glass microspheres, expanded polymeric microspheres, or expandable polymeric microspheres.

8. The two-part curable composition of claim 7, wherein the procatalyst comprises at least one of palladium or nickel.

9. The two-part curable composition of claim 7, wherein at least one of the first or second addition polymerizable cycloolefins is represented by the formula 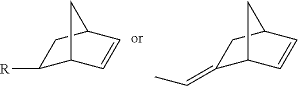
or a stereoisomer thereof, wherein R represents H or an alkyl group having up to ten carbon atoms.

10. The two-part curable composition of claim 7, wherein at least one of the Part A or the Part B further comprises an elastomeric toughener.

11. The two-part curable composition of claim 7, wherein at least one of the first or second addition polymerizable cycloolefins has at least two non-conjugated carbon-carbon double bonds that are polymerizable by addition polymerization.

12. The two-part curable composition of claim 7, wherein at least one of the Part A or the Part B further comprises a plasticizer.

13. A composite foam comprising:
a polymer matrix made by addition polymerization of at least one cycloolefin comprising a ring containing a single carbon-carbon double bond;
an addition polymerization catalyst; and
at least one of hollow glass microspheres or expanded polymeric microspheres.

14. The composite foam of claim 13, wherein the polymer matrix is crosslinked.

15. The composite foam of claim 13, wherein the polymer matrix has a glass transition temperature of at least 100° C.

16. The composite foam of claim 13, wherein at least one of the at least one cycloolefin is represented by the formula 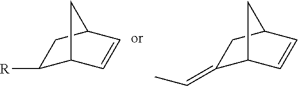
or a stereoisomer thereof, wherein R represents H or an alkyl group having up to ten carbon atoms.

17. The composite foam of claim 13, further comprising a plasticizer.

18. The composite foam of claim 13, wherein the composite foam has a dielectric constant of less than or equal to 2.5.

19. An article comprising a first substrate in contact with the composite foam of claim 13.

20. A method comprising:
providing a curable composition comprising an addition polymerizable cycloolefin comprising a ring containing a single carbon-carbon double bond;
an addition polymerization catalyst; and
at least one of hollow glass microspheres, expanded polymeric microspheres, or expandable polymeric microspheres; and
heating the curable composition to provide a composite foam according to claim 13.
